(19) United States
(12) Patent Application Publication
(10) Pub. No.: US 2026/0309599 A1
(43) Pub. Date: Oct. 8, 2026

(54) MATERIAL TESTING MACHINE

(71) Applicant: SHIMADZU CORPORATION, Kyoto (JP)

(72) Inventor: Hiroshi TSUJI, Kyoto-shi (JP)

(73) Assignee: SHIMADZU CORPORATION, Kyoto (JP)

(21) Appl. No.: 19/574,868

(22) Filed: Mar. 23, 2026

(30) Foreign Application Priority Data
Apr. 4, 2025 (JP) 2025-062421

(51) Int. Cl. G01N 3/06; G01N 3/08

(52) U.S. Cl. CPC G01N 3/066; G01N 3/08

(57) ABSTRACT

One aspect of a material testing machine according to the present invention comprises a detection unit configured to detect a test force by a strain gauge type sensor using a bridge circuit, a voltage application unit configured to apply an excitation voltage to the bridge circuit, and a voltage control unit configured to control the voltage application unit so as to apply a warm-up excitation voltage to the bridge circuit during at least a partial period between a start of application of the excitation voltage to the bridge circuit and execution of test force measurement, the warm-up excitation voltage being higher than a voltage value at the time of test force measurement by the detection unit and equal to or lower than a maximum voltage value allowed for the detection unit.

### TECHNICAL FIELD

The present invention relates to a material testing machine, and more particularly, to a material testing machine that measures a test force using a strain gauge type sensor.

### BACKGROUND ART

As an apparatus for measuring a test force in a tensile test, a compression test, or the like, a material testing machine using a load cell equipped with a strain gauge type sensor (or strain gauge type force sensor) is known. As described in Patent Document 1, a strain gauge type sensor includes a strain gauge bridge circuit that converts a change in electrical resistance of a strain gauge, which is deformed by a test force, into a voltage signal.

### Prior Art Documents

### Patent Documents

Patent Document 1: JP-A-2017-138172

Patent Document 2: JP-A-2009-281917

### SUMMARY OF THE INVENTION

### Problems to be Solved by the Invention

Since a DC voltage or an AC voltage is applied to the strain gauge bridge circuit as an excitation voltage, the circuit generates heat due to power loss. Therefore, a certain amount of time is required from the start of the application of the excitation voltage to the strain gauge bridge circuit until the internal temperature of the load cell stabilizes, that is, until the change in the internal temperature of the load cell becomes negligible. Particularly in a material testing machine, since the load cell is attached to a metal crosshead and heat conduction from the load cell to the crosshead is large, it may take a considerable amount of time until the internal temperature of the load cell stabilizes to an extent that does not affect the test force.

If the test force measurement is performed in a state where the internal temperature of the load cell is not sufficiently stable, the zero point or sensitivity of the test force may change during the measurement, and there is a possibility that a correct measurement result cannot be obtained. For this reason, generally, the test force measurement is performed after an appropriate standby time has elapsed from the time when the power of the material testing machine is turned on until the internal temperature of the load cell becomes stable to some extent. Further, a rated load is defined for a load cell, and when measuring a test force with a material testing machine, measurement may be repeated while exchanging load cells having different rated loads; however, when a load cell is exchanged, it is necessary to provide a standby time until the internal temperature of the load cell stabilizes, just as when the power is turned on (see Patent Document 2, etc.). However, providing a long standby time when turning on the power or exchanging the load cell leads to a decrease in measurement efficiency and also lowers the operation rate of the material testing machine.

The present invention has been made in view of the above problems, and its main object is to provide a material testing machine capable of shortening the standby time required until test force measurement and performing efficient measurement.

### Means for Solving the Problems

One aspect of the material testing machine according to the present invention comprises: a detection unit configured to detect a test force by a strain gauge type sensor using a bridge circuit; a voltage application unit configured to apply an excitation voltage to the bridge circuit; and a voltage control unit configured to control the voltage application unit so as to apply a warm-up excitation voltage to the bridge circuit during at least a partial period between a start of application of the excitation voltage to the bridge circuit and execution of test force measurement, the warm-up excitation voltage being higher than a voltage value at the time of test force measurement by the detection unit and equal to or lower than a maximum voltage value allowed for the detection unit.

### Effects of the Invention

In the material testing machine of the above aspect according to the present invention, a warm-up excitation voltage having a voltage value higher than the excitation voltage at the time of measurement is applied to the bridge circuit during the period from the start of application of the excitation voltage to the bridge circuit until the test force measurement is performed. When this warm-up excitation voltage is applied to the bridge circuit, heat generation in the bridge circuit is larger than when an excitation voltage of a voltage value suitable for test force measurement is applied. Therefore, according to the material testing machine of the above aspect of the present invention, the internal temperature of the load cell can be rapidly increased, for example, immediately after power-on or immediately after load cell exchange. Thereby, the standby time required until a state where accurate and reliable test force measurement can be performed is reached can be shortened, and efficient measurement can be performed.

### BRIEF DESCRIPTION OF DRAWINGS

FIG. 1 is an overall configuration diagram of main parts of a material testing machine according to an embodiment of the present invention.

FIG. 2 is an electrical block configuration diagram of the material testing machine of the present embodiment.

FIG. 3 is a functional block configuration diagram related to strain gauge bridge circuit driving, centering on a control unit and an operation unit in FIG. 2.

FIG. 4 is a diagram showing an example of a flowchart of excitation voltage control at the time of power-on or load cell exchange in the material testing machine of the present embodiment.

FIG. 5 is a schematic diagram showing an example of temporal changes in excitation voltage and temperature changes of a load cell in the material testing machine of the present embodiment and a conventional material testing machine.

### EMBODIMENTS FOR CARRYING OUT THE INVENTION

### Supplement to the above aspect

The "material testing machine" referred to herein typically includes an apparatus for measuring mechanical properties such as strength, hardness, fatigue properties, and impact properties of a material. It also includes an extensometer (or displacement gauge) for measuring deformation or displacement of a test piece, a width gauge for measuring the width of a test piece, and the like.

Further, the "bridge circuit" of the strain gauge type sensor is a circuit capable of detecting deformation (strain) occurring in a strain gauge as a change in electrical resistance. Various configurations such as a one-gauge method, a two-gauge method, and a four-gauge method are known as the configuration of this bridge circuit, but the circuit configuration is not limited to a specific one.

Further, the "excitation voltage" applied to the bridge circuit is a voltage for driving the bridge circuit, and may be either a DC voltage or an AC voltage.

Further, the time point of "start of application of the excitation voltage to the bridge circuit" referred to herein refers to a time point at which the excitation voltage is first applied immediately after the power of the material testing machine is turned on, or immediately after the detection unit is mounted in a case where the detection unit is configured to be attachable to and detachable from the apparatus main body. Therefore, for example, when the excitation voltage is intermittently applied to the bridge circuit during a period from when the power of the material testing machine is turned on until measurement is performed, it refers to the first time point in the intermittent application of the series of excitation voltages.

Hereinafter, an embodiment of a material testing machine according to the present invention will be described with reference to the accompanying drawings.

### Configuration of Material Testing Machine

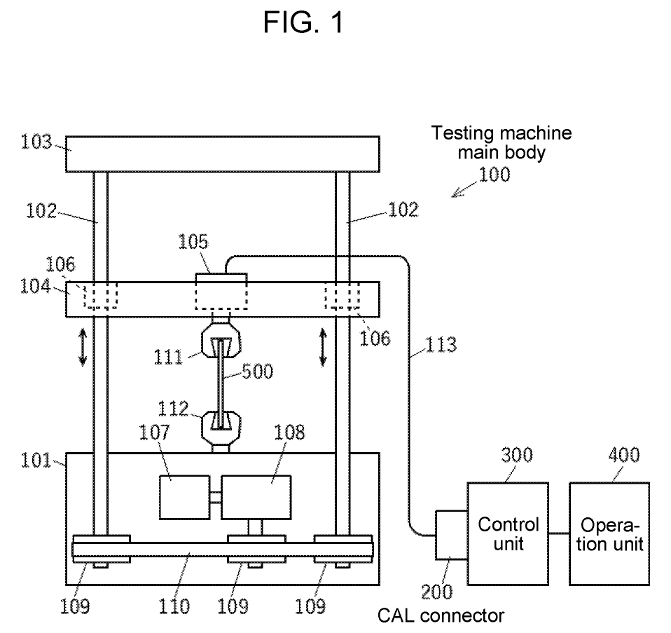

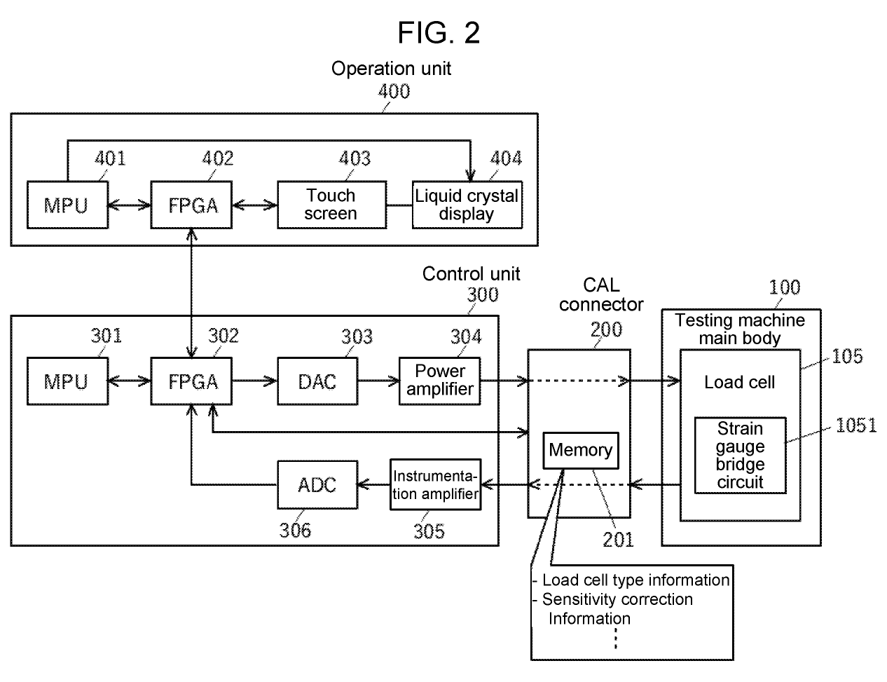

FIG. 1 is a configuration diagram of main parts in the material testing machine of the present embodiment. FIG. 2 is an electrical block diagram of the material testing machine of the present embodiment. In the following description, the right side in FIG. 1 is defined as right, and the upper side is defined as up, to define the vertical and horizontal directions of the material testing machine.

As shown in FIG. 1, the material testing machine of the present embodiment includes a testing machine main body 100, a control unit 300, and an operation unit 400.

The testing machine main body 100 includes a box-shaped base 101 whose upper part is a table, a pair of screw shafts 102 provided upright on the left and right of the base 101, and a yoke 103 holding the upper ends of the pair of screw shafts 102. A servo motor 107 and a gear box 108 are accommodated inside the base 101, and the rotation of the drive shaft of the servo motor 107 is transmitted to each screw shaft 102 via the gear box 108, a plurality of timing pulleys 109, and a timing belt 110, whereby the pair of screw shafts 102 rotate in synchronization with each other. A nut 106 is screwed onto each of the pair of screw shafts 102. A crosshead 104 is horizontally bridged between these nuts 106, and the crosshead 104 moves up and down as indicated by double-ended arrows in FIG. 1 in accordance with the rotation of the screw shafts 102.

An upper grip 111 is attached to the crosshead 104 via a load cell 105. On the other hand, a lower grip 112 is attached to a position corresponding to directly below the upper grip 111 on the base 101. In this material testing machine, a tensile test is performed on a test piece 500 by raising the crosshead 104 in a state where the upper end and the lower end of the test piece 500 are gripped by the upper grip 111 and the lower grip 112, respectively. In this tensile test, a test force (tensile force) applied to the test piece 500 as the crosshead 104 rises is detected by the load cell 105.

The load cell 105 is connected to a calibration (CAL) connector 200 via a cable 113, and the CAL connector 200 is connected to the control unit 300. The control unit 300 is connected to the operation unit 400. The control unit 300 also controls the servo motor 107 that raises and lowers the crosshead 104, but wiring for that purpose is omitted in FIG. 1.

The load cell 105 is attachable to and detachable from the crosshead 104. A plurality of load cells 105 having different rated loads are prepared, and a load cell 105 having an appropriate rated load is appropriately exchanged and used according to the test piece 500. Basically, the load cell 105 and the CAL connector 200 form a set, and when the load cell 105 is exchanged for one with a different rated load, the CAL connector 200 is also exchanged accordingly. This is because information regarding the load cell 105 is held inside the CAL connector 200, as will be described later. Note that the CAL connector 200 and the cable 113 may be integrated, or the load cell 105, the cable 113, and the CAL connector 200 may be integrated. Further, the function of the CAL connector 200 may be mounted on the load cell 105.

This material testing machine is configured such that by exchanging the upper grip 111 and the lower grip 112 with other jigs, material tests other than the tensile test on the test piece 500, such as a compression test, a bending test, a shear test, and a peeling test, can be performed, and tests on test pieces of various sizes and shapes can be performed.

The control unit 300 controls the testing machine main body 100 and the operation unit 400 and collects data on the test force, and as shown in FIG. 2, includes a microprocessing unit (MPU) 301, a field programmable gate array (FPGA) 302, a digital-to-analog converter (DAC), a power amplifier 304, an instrumentation amplifier 305, an analog-to-digital converter (ADC) 306, and the like. The MPU 301 executes various arithmetic processes according to programs stored in a memory in advance. The FPGA 302 executes logical operations determined by hardware and outputs predetermined numerical data.

The operation unit 400 is for an operator to input instructions to the control unit 300 or visually receive some information, and includes a microprocessing unit (MPU) 401 and a field programmable gate array (FPGA) 402, as well as a liquid crystal display 404 functioning as a display unit, a touch screen 403 functioning as an input unit, and the like. The FPGA 402 and the FPGA 302 have a function of communicating with each other, whereby data and control signals are exchanged between the control unit 300 and the operation unit 400. Note that the input unit in the operation unit 400 does not have to be the touch screen 403, and may use a general key switch panel or voice input.

The CAL connector 200 internally includes a memory 201 readable and writable from the outside and a R/W circuit (not shown) for reading and writing data from and to the memory 201. The memory 201 is accessible from the FPGA 302 of the control unit 300. The memory 201 holds information indicating the type of the load cell 105 paired with the CAL connector 200, information indicating the rated load, and the like. Information indicating a rated voltage value and a maximum voltage value of the excitation voltage described later may be held in the memory 201. Further, various data necessary for measurement, such as sensitivity correction information in test force measurement using the corresponding load cell 105, can also be written and held in the memory 201.

The load cell 105 includes a strain gauge that is deformed by a test force, and a strain gauge bridge circuit 1051 formed by a bridge circuit including the strain gauge, and the like. The control unit 300 applies an excitation voltage to the strain gauge bridge circuit 1051 via the CAL connector 200, and receives an electric signal corresponding to the deformation amount of the strain gauge in the strain gauge bridge circuit 1051 to perform arithmetic processing for calculating the test force.

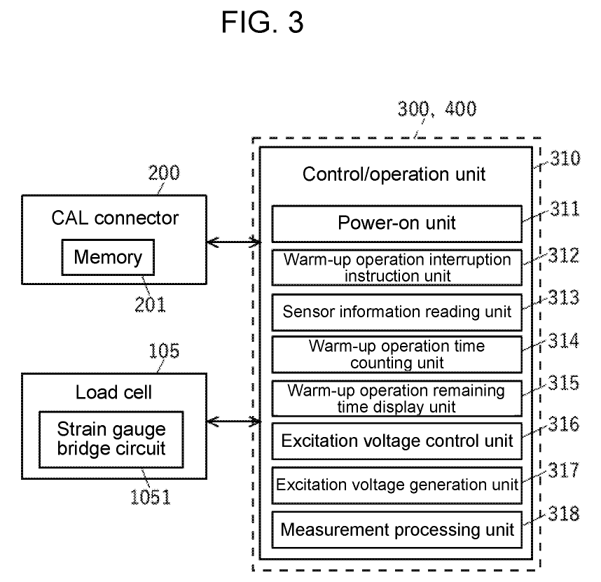

FIG. 2 shows the configuration of the control unit 300 and the operation unit 400 mainly from the viewpoint of devices, whereas FIG. 3 is a schematic configuration diagram showing the configuration of the control unit 300 and the operation unit 400 as functional blocks centering on the driving of the strain gauge bridge circuit 1051. As shown in FIG. 3, a control/operation unit 310 embodied by the control unit 300 and the operation unit 400 includes, as functional blocks, a power-on unit 311, a warm-up operation interruption instruction unit 312, a sensor information reading unit 313, a warm-up operation time counting unit 314, a warm-up operation remaining time display unit 315, an excitation voltage control unit 316, an excitation voltage generation unit 317, a measurement processing unit 318, and the like.

The power-on unit 311 includes, for example, a power switch (not shown) provided in the operation unit 400, and recognizes a power-on operation of the material testing machine by the operator. The warm-up operation interruption instruction unit 312 is embodied by the MPU 401, the FPGA 402, and the touch screen 403 in the operation unit 400, and recognizes an instruction to interrupt the warm-up operation in response to a predetermined input operation by the operator. The sensor information reading unit 313 accesses the memory 201 of the CAL connector 200 and reads information corresponding to a cell (the load cell 105 or another sensor) held in the memory 201. The warm-up operation time counting unit 314 performs a down-count from a predetermined warm-up operation time. In the following example, it is assumed that the predetermined warm-up operation time is 15 minutes, but this is an example, and the configuration may be such that this value can be appropriately changed by the operator or a service person of the manufacturer.

The warm-up operation remaining time display unit 315 displays the remaining time of the warm-up operation counted down by the warm-up operation time counting unit 314 in real time in a predetermined area on the screen of the liquid crystal display 404. The excitation voltage control unit 316 is embodied by the MPU 301, and determines and instructs a voltage value of the excitation voltage to be applied to the strain gauge bridge circuit 1051. The excitation voltage generation unit 317 is embodied by the FPGA 302, the DAC 303, and the power amplifier 304, and generates an excitation voltage having the voltage value determined by the excitation voltage control unit 316. Note that the excitation voltage may be either a DC voltage or an AC voltage (generally a sine wave voltage). The measurement processing unit 318 is embodied by the instrumentation amplifier 305, the ADC 306, the MPU 301, and the FPGA 302, and calculates a test force from an electric signal corresponding to the deformation amount of the strain gauge in the strain gauge bridge circuit 1051.

### Operation of Material Testing Machine of Present Embodiment

When the material testing machine of the present embodiment is in a power-off state, the load cell 105 is at approximately room temperature. When the power is turned on by the operator and the excitation voltage is applied to the strain gauge bridge circuit 1051, the strain gauge bridge circuit 1051 generates heat due to power loss, and the internal temperature of the load cell 105 starts to rise. It takes some time until the internal temperature of the load cell 105 rises to an extent that does not significantly affect the test force measurement and becomes generally stable, and if measurement is performed before that time elapses, the accuracy of the measurement cannot be ensured. On the other hand, if that time is long, the waiting time for the operator becomes long, leading to a decrease in measurement efficiency.

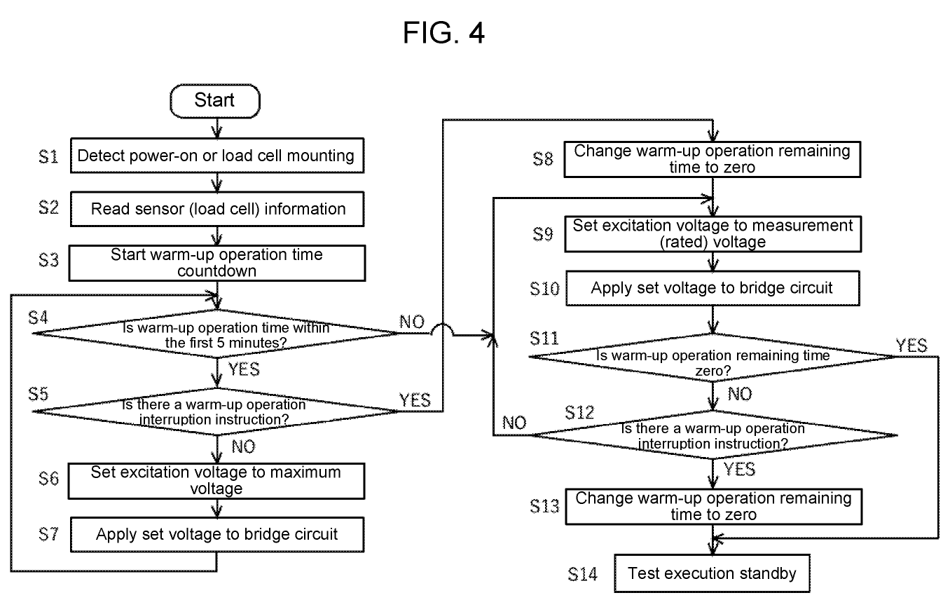

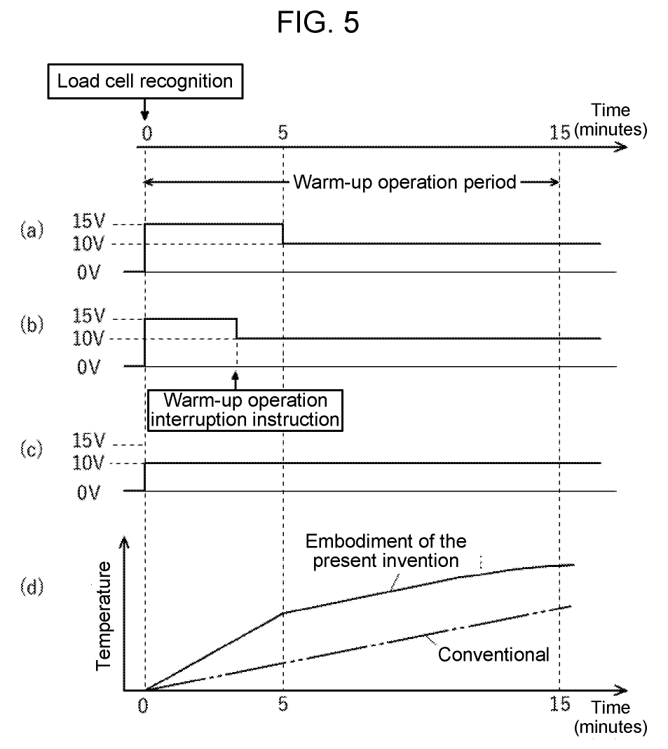

Therefore, in the material testing machine of the present embodiment, characteristic control is executed so that the internal temperature of the load cell 105 rises rapidly and stabilizes. This control will be described with reference to FIG. 4 and FIG. 5 in addition to FIGS. 1 to 3. FIG. 4 is a diagram showing an example of a flowchart of excitation voltage control at the time of power-on or load cell exchange, and FIG. 5 is a schematic diagram showing an example of temporal changes in excitation voltage and temperature changes of the load cell.

When the operator operates the power switch to turn on the power of this material testing machine, predetermined power is supplied from a power supply unit (not shown) to each part such as the control unit 300 (Step S1). The sensor information reading unit 313 accesses the memory 201 of the CAL connector 200 and reads data such as load cell type information held in the memory 201. Thereby, the control/operation unit 310 recognizes that the sensor connected via the CAL connector 200 is the load cell 105, that is, the connected sensor is one equipped with the strain gauge bridge circuit 1051 (Step S2).

In addition to the case where the power is turned on, also when the CAL connector 200 is newly connected to the control unit 300 due to the exchange of the load cell 105, upon detecting the mounting operation of the CAL connector 200, the sensor information reading unit 313 reads data such as load cell type information from the memory 201 of the newly mounted CAL connector 200. Therefore, both when the power is turned on and when the load cell 105 is exchanged, the sensor information reading unit 313 can recognize that the sensor indirectly connected to the control unit 300 is the load cell 105. Note that the control described below can also be performed when it is detected that a strain gauge type sensor using a strain gauge bridge circuit, such as an extensometer or a width gauge using a strain gauge type sensor instead of the load cell 105, is indirectly connected to the control unit 300.

When it is recognized that the load cell 105 is connected as described above, the warm-up operation time counting unit 314 starts counting down from the predetermined warm-up operation time (here, 15 minutes). The warm-up operation remaining time display unit 315 displays the numerical value of the warm-up operation remaining time being counted down in a predetermined display area in real time (Step S3). By this display of the remaining time, the operator can know the remaining time of the warm-up operation, that is, the waiting time until the state where measurement is possible is reached.

The excitation voltage control unit 316 determines whether or not the elapsed time with the countdown start time of the warm-up operation time as zero is within 5 minutes, that is, whether or not it is within the first 5 minutes of the predetermined warm-up operation time (Step S4). If YES is determined in Step S4, the excitation voltage control unit 316 determines whether or not there is an instruction to interrupt the warm-up operation by the warm-up operation interruption instruction unit 312 (Step S5).

The operator can instruct interruption of the warm-up operation at any time during the execution of the warm-up operation by performing a predetermined operation on the touch screen 403. For example, when the operator wants to know the result of the test force measurement quickly even if the accuracy may be poor in a state where the internal temperature of the load cell 105 has not risen sufficiently, the operator can interrupt the warm-up operation and proceed to measurement. Also, when the operator recognizes that the internal temperature of the load cell 105 is in a sufficiently high state, such as when the power is turned on again immediately after being turned off once, or when the load cell 105 and the CAL connector 200 used for measurement until then are once removed and reattached immediately, the operator can interrupt the warm-up operation and proceed to measurement. The warm-up operation interruption instruction unit 312 recognizes that there has been an instruction to interrupt the warm-up operation by the above-described operation of the operator, and notifies the excitation voltage control unit 316 that there has been an instruction to interrupt.

When the instruction to interrupt the warm-up operation has not been given by the operator, NO is determined in Step S5, and the excitation voltage control unit 316 sets the voltage value of the excitation voltage to the maximum voltage value allowed for the load cell 105 (Step S6). Information on this maximum voltage value may be held in the MPU 301 in advance, or may be read from the memory 201 of the CAL connector 200. As an example, it is assumed here that the maximum voltage value is 15V. The excitation voltage generation unit 317 generates a warm-up excitation voltage of the voltage value set by the excitation voltage control unit 316, that is, 15V which is the maximum voltage value in this case, and applies it to the strain gauge bridge circuit 1051 of the load cell 105 via the CAL connector 200 (Step S7).

Specifically, in the control unit 300, the MPU 301 instructs the FPGA 302 to output a voltage having the maximum voltage value, and in response to this, the FPGA 302 outputs a digital value of a voltage waveform corresponding to the instruction. When the excitation voltage is a DC voltage, the digital value of the voltage waveform is a constant numerical value. When the excitation voltage is an AC voltage, the digital value of the voltage waveform is a repetition of numerical values that change over time corresponding to one cycle of a sine wave voltage. The DAC 303 converts the digital value of the voltage waveform received from the FPGA 302 into an analog voltage, and the power amplifier 304 amplifies the voltage or current of the analog voltage output from the DAC 303 and outputs it. Thereby, a warm-up excitation voltage of 15V is applied to the strain gauge bridge circuit 1051 as shown in FIG. 5(a), and the temperature of the strain gauge bridge circuit 1051 starts to rise as shown by the solid line in FIG. 5(d). Note that when the excitation voltage is an AC voltage, the effective value of the AC voltage may be set as the maximum voltage value.

After Step S7, the process returns to Step S4. Therefore, unless an instruction to interrupt the warm-up operation is given by the operator, the processes of Steps S4 to S7 are repeated, and for the first 5 minutes from the start of the warm-up operation, the warm-up excitation voltage having a voltage value of 15V continues to be applied to the strain gauge bridge circuit 1051 as shown in FIG. 5(a). The voltage value at this time is higher than the voltage value of the excitation voltage applied to the strain gauge bridge circuit 1051 during test force measurement (rated voltage value: here, assumed to be 10V as an example). FIG. 5(c) is a diagram showing temporal changes in excitation voltage in a conventional material testing machine. As shown in this figure, conventionally, an excitation voltage of 10V, which is the rated voltage value, continues to be applied to the strain gauge bridge circuit 1051 from the start of application of the excitation voltage. Therefore, in the material testing machine of the present embodiment, an excitation voltage 1.5 times higher than that of the conventional material testing machine is applied to the strain gauge bridge circuit 1051.

When 5 minutes have elapsed from the start of the warm-up operation by repeating the processes of Steps S4 to S7, NO is determined in Step S4, and the process proceeds to Step S9. Then, the excitation voltage control unit 316 changes the setting of the voltage value of the excitation voltage to the excitation voltage at the time of measurement, that is, 10V which is the rated voltage value. The excitation voltage generation unit 317 generates an excitation voltage of the voltage value set by the excitation voltage control unit 316, that is, 10V which is the rated voltage value in this case, and applies it to the strain gauge bridge circuit 1051 of the load cell 105 via the CAL connector 200 (Step S10). Specifically, in the control unit 300, the MPU 301 instructs the FPGA 302 to output a voltage of the rated voltage value instead of the voltage of the maximum voltage value, and in response to this, the FPGA 302 outputs a digital value of a voltage waveform corresponding to the instruction. Therefore, as shown in FIG. 5(a), when 5 minutes have elapsed from the start of application of the excitation voltage, the excitation voltage applied to the strain gauge bridge circuit 1051 switches from 15V to 10V.

Returning to the repetition of the processes of Steps S4 to S7, the description continues. If the operator instructs interruption of the warm-up operation before 5 minutes have elapsed from the start of the warm-up operation, YES is determined in Step S5, and the process proceeds to Step S8. Then, the warm-up operation time counting unit 314 changes the remaining time to zero regardless of the warm-up operation remaining time. Along with this, the remaining time displayed on the warm-up operation remaining time display unit 315 also becomes zero. Thereafter, since the process proceeds from Step S9 to S10, the excitation voltage applied to the strain gauge bridge circuit 1051 switches from 15V to 10V as described above. FIG. 5(b) shows an example of the change in excitation voltage when the warm-up operation is interrupted before 5 minutes have elapsed from the start of the warm-up operation in this way.

After Step S10, the excitation voltage control unit 316 determines whether or not the warm-up operation remaining time at that time is zero (Step S11), and if it is not zero, next, similarly to Step S5, determines whether or not there is an instruction to interrupt the warm-up operation by the warm-up operation interruption instruction unit 312 (Step S12). If there is no instruction to interrupt the warm-up operation, the process returns to Step S9. Therefore, if there is no instruction to interrupt the warm-up operation by the operator until the predetermined warm-up operation time, that is, 15 minutes have elapsed, the processes of Steps S9 to S12 are repeated. That is, 10V, which is the rated voltage, is applied as the excitation voltage to the strain gauge bridge circuit 1051. Thereby, the heat generation amount of the strain gauge bridge circuit 1051 becomes smaller than that in the period until 5 minutes have elapsed from the start of excitation voltage application, and as shown in FIG. 5(d), the rise in the internal temperature of the load cell 105 becomes moderate. Then, as the warm-up operation remaining time approaches zero, the degree of rise in the internal temperature of the load cell 105 becomes moderate and approaches a stable state.

When it is determined by the excitation voltage control unit 316 that the warm-up operation remaining time is zero, the process proceeds from Step S11 to Step S14, and the control/operation unit 310 enters a test execution standby state while keeping 10V, which is the rated voltage, applied to the strain gauge bridge circuit 1051 as the excitation voltage. On the other hand, if the operator instructs interruption of the warm-up operation during the repetition of the processes of Steps S9 to S12 and before 15 minutes have elapsed from the start of the warm-up operation, YES is determined in Step S12. Then, similarly to Step S8, the warm-up operation time counting unit 314 changes the remaining time to zero regardless of the warm-up operation remaining time (Step S13), and the process proceeds to Step S14. Therefore, in this case, the state becomes the test execution standby state without waiting for the elapse of 15 minutes from the start of the warm-up operation. Note that if the warm-up operation remaining time becomes zero in Step S8, YES is determined in the next Step S11 after passing through Steps S9 and S10, so the state becomes the test execution standby state without waiting for the elapse of 5 minutes from the start of the warm-up operation.

The relationship between the flow of processing according to the above flowchart and the state of the excitation voltage applied to the strain gauge bridge circuit 1051 will be summarized. When the process proceeds from Step S4 to Step S9 in the repetition of the processes of Steps S4 to S7, and thereafter proceeds from Step S11 to Step S14 in the repetition of the processes of Steps S9 to S12, the temporal change of the excitation voltage is as shown in FIG. 5(a). In this case, electric power corresponding to a voltage value 1.5 times higher, which is the ratio between the maximum voltage value and the rated voltage value, continuing for 5 minutes is input to the strain gauge bridge circuit 1051 more than in the conventional material testing machine (FIG. 5(c)). Therefore, the time required for the internal temperature of the load cell 105 to stabilize is considerably shortened compared to the conventional material testing machine as shown in FIG. 5(d).

Also, when the process proceeds from Step S4 to Step S9 in the repetition of the processes of Steps S4 to S7, and thereafter proceeds from Step S12 to Step S13 in the repetition of the processes of Steps S9 to S12, electric power corresponding to a voltage value 1.5 times higher, which is the ratio between the maximum voltage value and the rated voltage value, continuing for 5 minutes is input to the strain gauge bridge circuit 1051 more than in the conventional material testing machine. Therefore, the time required for the internal temperature of the load cell 105 to stabilize is considerably shortened compared to the conventional material testing machine.

On the other hand, when the process proceeds from Step S5 to Step S8 in the repetition of the processes of Steps S4 to S7, the temporal change of the excitation voltage is as shown in FIG. 5(b). In this case, although the electric power input to the strain gauge bridge circuit 1051 decreases by the amount that the time during which the maximum voltage of 15V is applied to the strain gauge bridge circuit 1051 becomes shorter, the time required for the internal temperature of the load cell 105 to stabilize is shortened compared to the conventional material testing machine.

When the display of the warm-up operation remaining time becomes zero and the state is the test execution standby state in Step S14, if the operator performs a predetermined operation on the touch screen 403, for example, the crosshead 104 rises, whereby a tensile test is performed on the test piece 500. During the execution of this test, a voltage signal proportional to the test force is output from the strain gauge bridge circuit 1051 and input to the measurement processing unit 318 via the CAL connector 200. The measurement processing unit 318 performs processing for converting the received voltage signal into a test force, and displays the result in a predetermined area on the screen of the liquid crystal display 404.

Specifically, the instrumentation amplifier 305 amplifies the voltage signal received from the strain gauge bridge circuit 1051, and the ADC 306 converts the analog voltage output from the instrumentation amplifier 305 into a digital value. The output of the ADC 306 is input to the FPGA 302, and the FPGA 302 calculates the test force by multiplying the read digital voltage value by a conversion coefficient sent from the MPU 301. Even if the test force value is the same, if the excitation voltage applied to the strain gauge bridge circuit 1051 is different, the voltage signal output from the strain gauge bridge circuit 1051 is different. Therefore, when the test force value is the same, the conversion coefficient is adjusted so that the converted test force value becomes the same even if the voltage signal output from the strain gauge bridge circuit 1051 is different because the excitation voltage applied to the strain gauge bridge circuit 1051 is different. That is, the MPU 301 sends a conversion coefficient corresponding to the voltage value of the excitation voltage to the FPGA 302, and the FPGA 302 performs multiplication using the conversion coefficient, thereby making it possible to obtain an accurate test force regardless of the voltage value of the excitation voltage applied to the strain gauge bridge circuit 1051.

The material testing machine of the present embodiment has the following advantages over the conventional material testing machine because the warm-up excitation voltage having a voltage value higher than the excitation voltage at the time of measurement is applied to the strain gauge bridge circuit 1051 during at least a part of the period during the warm-up operation, as described above. (1) When the warm-up operation is performed for the same time as the conventional material testing machine, the stability of the internal temperature of the load cell 105 is increased compared to the conventional material testing machine, so that more accurate, reproducible, and highly reliable test force measurement can be performed. (2) Even when the warm-up operation time is shortened compared to the conventional material testing machine, or even when the test force measurement is performed by interrupting the warm-up operation in the middle of the warm-up operation (that is, by shortening the time compared to the conventional warm-up operation time), the test force measurement can be performed with accuracy and reliability equal to or higher than or close to that when the warm-up operation is sufficiently performed in the conventional material testing machine. Thereby, the warm-up operation time, that is, the standby time can be reduced, and the efficiency of test force measurement can be increased while ensuring accuracy.

To give an example, in a general load cell (input resistance: 350 Ω, rated voltage: 10V), when the rated voltage is applied as the excitation voltage, heat generation of 10² / 350 = 286 mW occurs inside the load cell. On the other hand, when a warm-up excitation voltage having a voltage value of 15V is applied only for the first 5 minutes of the warm-up operation, the heat generation amount inside the load cell becomes 15² / 350 = 643 mW, and a heat generation amount of 2.25 times is obtained. That is, if the excitation voltage is increased, the heat generation amount is affected by the square of the voltage value, so the effect is large. Thus, in the material testing machine of the present embodiment, the amount of heat generated in the strain gauge bridge circuit 1051 can be increased, and the temperature of the load cell 105 can be raised in a shorter time.

As another method for shortening the time until the temperature of the entire interior of the load cell stabilizes, lowering the excitation voltage itself at the time of measurement applied to the strain gauge bridge circuit is also conceivable as an idea. However, if the excitation voltage is lowered, the S/N ratio of the voltage signal corresponding to the test force obtained by the strain gauge bridge circuit decreases, and it becomes impossible to determine the test force with high accuracy. Therefore, it is not appropriate to lower the excitation voltage at the time of measurement. From this viewpoint as well, the control method of the excitation voltage adopted in the material testing machine of the present embodiment can be said to be an excellent method because it leads to shortening of the standby time without impairing the accuracy of test force measurement.

### Modifications

In the material testing machine of the above embodiment, immediately after starting to apply the excitation voltage to the strain gauge bridge circuit 1051 immediately after power-on or immediately after connection of the load cell 105 to the control unit 300, the warm-up excitation voltage of the maximum voltage value allowed for the load cell 105 is applied for only 5 minutes, and thereafter, the excitation voltage applied to the strain gauge bridge circuit 1051 is returned to the rated voltage value. The present invention is not limited to this, and the time for applying the warm-up voltage may be longer or shorter. Further, instead of immediately after starting to apply the excitation voltage to the strain gauge bridge circuit 1051, an excitation voltage that is the rated voltage value may be applied initially, and the voltage value of the excitation voltage may be increased after a while. That is, the warm-up excitation voltage may be applied at any timing during the warm-up operation period, and the period during which the warm-up excitation voltage is applied may be a part of or the whole of the warm-up operation period.

Further, instead of raising the excitation voltage to the maximum voltage value, it is clear that raising it to a voltage value higher than at least the voltage value at the time of measurement, that is, the rated voltage value, is effective for quickening the internal temperature rise of the load cell 105. Further, during the warm-up operation period, the excitation voltage may be changed continuously or stepwise over time. For example, it is conceivable to set the excitation voltage to a voltage value as high as possible, such as the maximum voltage value, at the beginning of the warm-up operation period, and change the excitation voltage so as to approach the rated voltage value as time elapses. Thus, various patterns of change in the excitation voltage during the warm-up operation are conceivable.

Further, when the maximum voltage value and the rated voltage value differ depending on the type of the load cell 105 used by being attached to the crosshead 104, as described above, information on the maximum voltage value and the rated voltage value corresponding to the load cell 105 is stored in the memory 201 built in the CAL connector 200, and based on the information read by the FPGA 302, the MPU 301 may instruct the FPGA 302 which of the maximum voltage value or the rated voltage value to output. Alternatively, information on the maximum voltage value and the rated voltage value corresponding to the load cell 105 may be held in the MPU 301, and based on the load cell type information read from the memory 201, the maximum voltage value and the rated voltage value may be respectively selected and instructed to the FPGA 302. Of course, a method of allowing the operator to input or select the maximum voltage value and the rated voltage value corresponding to the load cell 105 to be used is also conceivable.

Further, in the material testing machine of the above embodiment, the load cell is used to measure the test force, but the sensor connected to the control unit is not limited to the load cell as long as it measures the test force by a strain gauge type sensor using a strain gauge bridge circuit. Therefore, the present invention is not limited to a general-purpose material testing machine, but is obviously applicable to, for example, an extensometer (or displacement gauge) or a width gauge using a strain gauge type sensor using a strain gauge bridge circuit as an elongation detector, and further to a material testing machine for measuring a test force on a specific test object such as a spring, plastic, concrete, or rubber.

Furthermore, the above embodiment and the above-described modifications are merely examples of the present invention, and it is obvious that even if changes, additions, deletions, etc. are further made within the scope of the spirit of the present invention, they are included in the scope of the claims of the present application.

### Various Aspects

It is understood by those skilled in the art that the above-described exemplary embodiments are specific examples of the following aspects.

(Item 1) One aspect of the material testing machine according to the present invention comprises: a detection unit configured to detect a test force by a strain gauge type sensor using a bridge circuit; a voltage application unit configured to apply an excitation voltage to the bridge circuit; and a voltage control unit configured to control the voltage application unit so as to apply a warm-up excitation voltage to the bridge circuit during at least a partial period between a start of application of the excitation voltage to the bridge circuit and execution of test force measurement, the warm-up excitation voltage being higher than a voltage value at the time of test force measurement by the detection unit and equal to or lower than a maximum voltage value allowed for the detection unit.

In the material testing machine according to Item 1, a warm-up excitation voltage of, for example, the maximum voltage value allowed for the detection unit is applied to the bridge circuit during the period from the start of application of the excitation voltage to the bridge circuit until the test force measurement is performed. When such a warm-up excitation voltage is applied to the bridge circuit, heat generation in the bridge circuit is larger than when an excitation voltage of a voltage value suitable for test force measurement is applied. Therefore, according to the material testing machine described in Item 1, the internal temperature of the detection unit such as a load cell can be rapidly increased and stabilized immediately after power-on or immediately after load cell exchange. Thereby, the standby time required until a state where accurate and reliable test force measurement can be performed is reached is shortened, and efficient measurement can be performed.

(Item 2) In the material testing machine according to Item 1, the voltage control unit may control the voltage application unit so as to apply an excitation voltage, which is the voltage value at the time of test force measurement by the detection unit, to the bridge circuit from the start of application of the excitation voltage to the bridge circuit, excluding the at least partial period.

In the material testing machine according to Item 2, an excitation voltage having a voltage value lower than the warm-up excitation voltage is applied to the bridge circuit during periods other than the period during which the warm-up excitation voltage is applied to the bridge circuit. Thereby, it is possible to avoid the internal temperature of the detection unit from rising more than necessary, and to allow the internal temperature to settle into a stable state quickly. Further, the test force measurement can be performed immediately in a state where the internal temperature of the detection unit is generally stable.

(Item 3) In the material testing machine according to Item 1 or 2, the voltage control unit may control the voltage application unit so as to apply the warm-up excitation voltage of the maximum voltage value allowed for the detection unit to the bridge circuit during the at least partial period.

According to the material testing machine described in Item 3, the internal temperature of the detection unit can be rapidly increased while avoiding application of an excessive voltage to the bridge circuit of the detection unit.

(Item 4) In the material testing machine according to any one of Items 1 to 3, the at least partial period may be a period starting from a time point of start of application of the excitation voltage to the bridge circuit or immediately thereafter.

In the material testing machine according to Item 4, the warm-up excitation voltage is applied to the bridge circuit from the beginning of the start of application of the excitation voltage to the bridge circuit. Thereby, the internal temperature of the detection unit can be efficiently increased, and the time until the internal temperature reaches a stable state can be further shortened.

(Item 5) In the material testing machine according to any one of Items 1 to 4, a period from the start of application of the excitation voltage to the bridge circuit until a predetermined time elapses is defined as a warm-up operation period, and the at least partial period may be a period from the time point of start of application of the excitation voltage to the bridge circuit or immediately thereafter until before the warm-up operation period ends.

In the material testing machine according to Item 5, a period of warm-up operation is determined in advance, and the measurement of the test force is performed after the period ends. Thereby, the test force measurement can be performed after the internal temperature of the detection unit has become a generally stable state, and accurate and highly reproducible results can be obtained.

(Item 6) The material testing machine according to Item 5 further includes an operation reception unit configured to receive an operation of interruption of the warm-up operation by an operator, wherein the voltage control unit may control the voltage application unit so as to end the warm-up operation period and apply an excitation voltage, which is the voltage value at the time of test force measurement by the detection unit, to the bridge circuit in response to reception of the operation of interruption of the warm-up operation by the operation reception unit.

In the material testing machine according to Item 6, the operator can interrupt the warm-up operation and promptly perform the test force measurement at his/her discretion. Thereby, for example, when it is desired to obtain a measurement result quickly even if accuracy is sacrificed to some extent, or when it is known that the internal temperature of the detection unit is in a sufficiently stable state, the measurement result can be obtained immediately without providing a waiting time.

(Item 7) In the material testing machine according to any one of Items 1 to 6, the voltage control unit may start application of the excitation voltage to the bridge circuit immediately after power-on of the material testing machine.

According to the material testing machine described in Item 7, it is possible to shorten the waiting time until appropriate test force measurement becomes possible after the operator turns on the power of the material testing machine.

(Item 8) In the material testing machine according to any one of Items 1 to 7, the detection unit is attachable to and detachable from the material testing machine, and the material testing machine further includes a mounting detection unit configured to detect that the detection unit is mounted to the material testing machine, wherein the voltage control unit may start application of the excitation voltage to the bridge circuit immediately after mounting of the detection unit is detected by the mounting detection unit.

According to the material testing machine described in Item 8, since the application of the excitation voltage to the bridge circuit starts without performing any special operation after the operator exchanges the detection unit such as a load cell, operability can be improved. Further, it is possible to shorten the waiting time until appropriate test force measurement becomes possible after exchanging the detection unit.

(Item 9) In the material testing machine according to any one of Items 1 to 8, the detection unit may be a load cell, an extensometer, a displacement gauge, or a width gauge.

According to the material testing machine described in Item 9, the test force in various tests on a test piece, such as a tensile test, a compression test, a bending test, a shear test, and a peeling test, can measure the strain amount accurately and efficiently.

### Description of Reference Signs

100 ... Testing machine main body

101 ... Base

102 ... Screw shaft

103 ... Yoke

104 ... Crosshead

105 ... Load cell

1051 ... Strain gauge bridge circuit

106 ... Nut

107 ... Servo motor

108 ... Gear box

109 ... Timing pulley

110 ... Timing belt

111 ... Upper grip

112 ... Lower grip

113 ... Cable

200 ... CAL connector

201 ... Memory

300 ... Control unit

400 ... Operation unit

301, 401 ... MPU

302, 402 ... FPGA

303 ... DAC

304 ... Power amplifier

305 ... Instrumentation amplifier

306 ... ADC

403 ... Touch screen

404 ... Liquid crystal display

310 ... Control/operation unit

311 ... Power-on unit

312 ... Warm-up operation interruption instruction unit

313 ... Sensor information reading unit

314 ... Warm-up operation time counting unit

315 ... Warm-up operation remaining time display unit

316 ... Excitation voltage control unit

317 ... Excitation voltage generation unit

318 ... Measurement processing unit

500 ... Test piece

1. A material testing machine comprising: a detection unit configured to detect a test force by a strain gauge type sensor using a bridge circuit; a voltage application unit configured to apply an excitation voltage to the bridge circuit; and a voltage control unit configured to control the voltage application unit so as to apply a warm-up excitation voltage to the bridge circuit during at least a partial period between a start of application of the excitation voltage to the bridge circuit and execution of test force measurement, the warm-up excitation voltage being higher than a voltage value at the time of test force measurement by the detection unit and equal to or lower than a maximum voltage value allowed for the detection unit.

2. The material testing machine according to claim 1, wherein the voltage control unit controls the voltage application unit so as to apply an excitation voltage, which is the voltage value at the time of test force measurement by the detection unit, to the bridge circuit from the start of application of the excitation voltage to the bridge circuit, excluding the at least partial period.

3. The material testing machine according to claim 1, wherein the voltage control unit controls the voltage application unit so as to apply the warm-up excitation voltage of the maximum voltage value allowed for the detection unit to the bridge circuit during the at least partial period.

4. The material testing machine according to claim 1, wherein the at least partial period is a period starting from a time point of start of application of the excitation voltage to the bridge circuit or immediately thereafter.

5. The material testing machine according to claim 1, wherein a period from the start of application of the excitation voltage to the bridge circuit until a predetermined time elapses is defined as a warm-up operation period, and the at least partial period is a period from the time point of start of application of the excitation voltage to the bridge circuit or immediately thereafter until before the warm-up operation period ends.

6. The material testing machine according to claim 5, further comprising an operation reception unit configured to receive an operation of interruption of the warm-up operation by an operator, wherein the voltage control unit controls the voltage application unit so as to end the warm-up operation period and apply an excitation voltage, which is the voltage value at the time of test force measurement by the detection unit, to the bridge circuit in response to reception of the operation of interruption of the warm-up operation by the operation reception unit.

7. The material testing machine according to claim 1, wherein the voltage control unit starts application of the warm-up excitation voltage to the bridge circuit immediately after power-on of the material testing machine.

8. The material testing machine according to claim 1, wherein the detection unit is attachable to and detachable from the material testing machine, and the material testing machine further includes a mounting detection unit configured to detect that the detection unit is mounted to the material testing machine, wherein the voltage control unit starts application of the warm-up excitation voltage to the bridge circuit immediately after mounting of the detection unit is detected by the mounting detection unit.

9. The material testing machine according to claim 1, wherein the detection unit is a load cell, an extensometer, a displacement gauge, or a width gauge.
